(19) United States
(12) Patent Application Publication
(10) Pub. No.: US 2008/0008372 A1
(43) Pub. Date: Jan. 10, 2008

(54) A METHOD AND SYSTEM FOR REDUCING ARTIFACTS IN A TOMOSYNTHESIS IMAGING SYSTEM

(75) Inventors: Baojun Li, Waukesha, WI (US); Xianfeng Ni, Merton, WI (US); Kadri Nizar Jabri, Waukesha, WI (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/456,183

(22) Filed: Jul. 7, 2006

(51) Int. Cl. G06K 9/00; G06K 9/40

(52) U.S. Cl. 382/131; 382/275

(57) ABSTRACT

The present invention provides a method and system for reducing artifacts in tomosynthesis reconstructed images. The artifacts reduction method comprises back-projecting only a part of the projection image. The method includes acquiring plurality of projection images from different projection angles. It further includes identifying an area of interest of each projection image based on a predefined area and back project the area of interest of each projection image to reconstruct at least one three dimensional image. In an embodiment the area of interest of the projection image is identified based on field of view of the collimator. In another embodiment the invention provides a tomosynthesis system producing a 3-D image with reduced reducing artifacts.

### FIELD OF THE INVENTION

This invention generally relates to an imaging system and more particularly to, methods and systems for reducing artifacts in tomosynthesis reconstructed images.

### BACKGROUND OF THE INVENTION

In classical tomography, the X-ray source and detector move synchronously and continuously in opposite directions about a fulcrum residing in the plane of interest. The tomography procedure produces an image, or tomogram, of the desired plane by blurring the contributions from other planes. In tomosynthesis, a set of component radiographs is generated by pulsing the source at discrete intervals along the path used in classical tomography. The component images are superimposed and translated with respect to each other to synthesize a tomogram. The plane of focus is selectable as a function of translation distance. A single exposure sequence can produce many planes for viewing by varying the shifting and adding of the tomography data.

Digital tomosynthesis (DTS) is a limited angle imaging technique, which allows the reconstruction of tomographic planes on the basis of the information contained within the images acquired during one tomographic image acquisition. A set of 2-D images of the object is obtained and a 3-D image is generated from the same. For generating 3-D images, normally back projection techniques are used. In digital tomosynthesis, for example, one backprojection technique known as “simple backprojection” or the “shift and add algorithm” is often used to reconstruct images (e.g., 3D images) due to its relatively straightforward implementation and minimal computational power requirements. The shift and add algorithm, however, introduces reconstruction artifacts. In fact, high contrast out-of-plane structures tend to appear as several relatively low-contrast copies in a reconstructed horizontal slice through the object. Also, the loss in contrast for small structures is not recovered by the simple back-projection reconstruction technique. Thus, the conventional shift and add algorithm suffers from considerable problems in this field of use. Another reconstruction method used in tomosynthesis is known as the algebraic reconstruction technique (ART). ART tends to generate higher quality reconstructions than the shift and add algorithm, but is typically much more computational heavy than other techniques (e.g., the shift and add algorithm).

However all these reconstructions algorithms introduce some sort of noticeable artifacts to the reconstructed images. There are several techniques present in various imaging system to reduce the artifacts. Additionally, most of the imaging device use collimator to minimize the radiation exposure to the object being imaged. The effect of collimation will introduce some sort of artifacts in the projected images. The artifacts particularly generated due to the effect of a collimation device, generally known as collimation artifacts, line artifacts, staircase artifacts or collimation edge artifacts. Further, recent developments of various computer graphic techniques applied to tomosynthesis, however, have discovered additional artifacts. These artifacts appear as periodical rings or grooves superimposed on the surface of the 3D image.

It would be desirable to provide an algorithm and a method which facilitates the reduction of artifacts in 3D images. It also would be desirable to improve the image quality by reducing the disturbing line artifacts in the reconstructed images in a digital tomosynthesis system.

### SUMMARY OF THE INVENTION

The above-mentioned shortcomings, disadvantages and problems are addressed herein which will be understood by reading and understanding the following specification.

The present invention provides method of reducing artifacts in tomosynthesis reconstructed images. The method comprising the steps of:-(a) acquiring a plurality of projection images from different projection angles; (b) defining an area of interest of each projection image based on at least one predefined area; and (c) back-projecting the area of interest of each projection image to reconstruct at least one three dimensional image. In an embodiment the predefined area is defined by the field of view of the collimator used in the imaging device.

In another embodiment, a system to construct a three-dimensional image of an object using tomosynthesis is provided. The system comprises a computer programmed to (a) define area of interest of a plurality of projection image after image data acquisition, based on at least one predefined area; and (b)back project the area of interest of each projection image for reconstructing at least one 3D image.

In yet another embodiment a tomosynthesis system with improved artifacts reduction is provided. The system comprises: an X-ray source configured to project an X-ray beam from a plurality of positions through an object to be imaged; and a collimator placed between the source and object to be imaged. The system further comprises a detector configured to produce a plurality of signals corresponding to the X-ray beam; and a computer configured to process the plurality of signals to generate a plurality of projection images, each projection image comprising a respective plurality of pixels. The computer is further configured to define area of interest of a plurality of projection image after image data acquisition, based on at least one predefined area; and back project the area of interest of each projection image for reconstructing at least one 3D image

Various other features, objects, and advantages of the invention will be made apparent to those skilled in the art from the accompanying drawings and detailed description thereof.

### BRIEF DESCRIPTION OF THE DRAWINGS

FIG. 1 illustrates a schematic diagram of a digital tomosynthesis imaging system capable of using a collimation artifacts reduction method described in an embodiment of the invention;

FIG. 2 illustrates a schematic diagram illustrating a method of tomosynthesis in accordance an embodiment of the present invention;

FIG. 3 illustrates exemplary field of views seen in projection images in a tomosynthesis system in accordance with embodiments of the present invention;

FIG. 4 is a high level flowchart depicting exemplary steps of collimation artifacts reduction method in a tomosynthesis imaging system in accordance with an embodiment of the present invention;

FIG. 5 is a flowchart describing, in greater detail, exemplary steps of collimation artifacts reduction method in accordance with aspects of the present technique illustrated in FIG. 4;

FIG. 6 illustrates a reconstructed image in a tomographic synthesis imaging system according to the prior art; and

FIG. 7A and FIG. 7B illustrate a side-by-side comparison of reconstructed image before (FIG. 7A) and after (FIG. 7B) using the method disclosed in an embodiment of the invention.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

In various embodiments, the method according to the invention comprising the steps of:(a) acquiring a plurality of projection images from different projection angles; (b) defining an area of interest of each projection image based on at least one predefined area; and (c) back-projecting the area of interest of each projection image to reconstruct at least one three dimensional image.

While the present technique is described herein with reference to medical imaging applications, it should be noted that the invention is not limited to this or any particular application or environment. Rather, the technique may be employed in a range of applications, such as baggage and parcel handling and inspection, part inspection and quality control, and so forth, to mention but a few.

The present invention also provides a system to construct a three-dimensional image of an object using tomosynthesis with significantly improved collimator artifacts reduction and improved image quality.

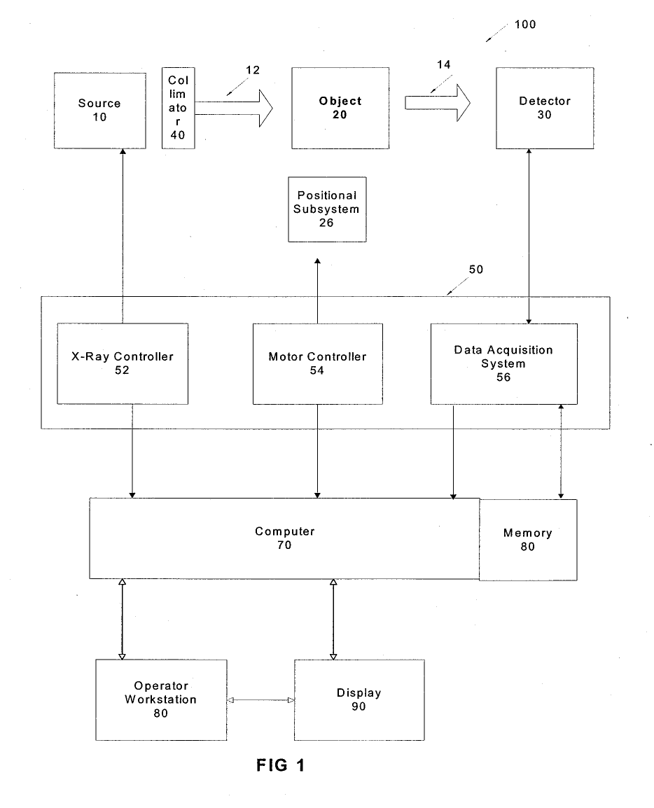

FIG. 1 illustrates diagrammatically an imaging system 100 which may be used for acquiring and processing projection image data and reconstructing a volumetric image or 3D image representative of the imaged object. In the illustrated embodiment, the system 100 is a tomosynthesis system designed both to acquire projection image data, and to process the image data for display and to analyze the reduction in artifacts in accordance with the present technique. In the embodiment illustrated in FIG. 1, the imaging system 100 includes a source 10 of radiation, which is typically X-ray radiation in tomosynthesis; the source 10 is freely movable relative to the imaged object. In this exemplary embodiment, the X-ray radiation source 10 typically includes an X-ray tube and associated support and filtering components. In certain systems, however, more than one source of radiation may be employed.

A stream of radiation 12 is emitted by the source 10 and impinges an object 20, for example, a patient in medical applications. A portion of the radiation 14 passes through or around the object 20 and impacts a detector array, represented generally at reference numeral 30. Detector elements of the array produce electrical signals that represent the intensity of the incident X-ray beam. These signals are acquired and processed to reconstruct a volumetric image or 3D image of the features within the object.

A collimator 40 is a device used in medical imaging applications to limit the field of an X-ray beam to a shape and size just sufficient to expose the area requiring diagnosis in a patient's body, and prevent unnecessary exposure of the surrounding area to X-rays. A collimator 40 may be placed before or after the patient or object on need basis. Generally in digital tomosynthesis pre-patient collimation is used The collimator 40 may define the size and shape of the X-ray beam 12 that emerges from the X-ray source 10. Apparently, the collimator 40 defines the field of view (FOV) in the projection images so that unnecessary radiation to patient anatomy outside the regions of clinical interest can be avoided or minimized.

Source 10 is controlled by a controlling device 50 which furnishes both power and control signals for tomosynthesis examination sequences, including positioning of the source 10 relative to the object 20 and the detector 30. Moreover, detector 30 is coupled to the controlling device 50, which commands acquisition of the signals generated in the detector 30. The controlling device 50 may also execute various signal processing and filtration functions, such as for initial adjustment of dynamic ranges, interleaving of digital image data, and so forth. In general, controlling device 50 commands operation of the imaging system 100 to execute examination protocols and to process acquired data. In the present context, controlling device 50 also includes signal processing circuitry, typically based upon a general purpose or application-specific digital computer, associated memory circuitry for storing programs and routines executed by the computer, as well as configuration parameters and image data, interface circuits, and so forth. The controlling device 50 coordinates with the imaging device 100 identifying the edges of the collimation. This is achieved by the conventionally used techniques including “accurate device feed back”, “image based detection method” or a combination of two or any other similar techniques present in the industry.

In the embodiment illustrated in FIG. 1, controlling device 50 is coupled to a positional subsystem 26 ( not shown in detail) which positions the X-ray source 10 relative to the object 20 and the detector 30. In alternative embodiments the positional subsystem 26 may make the detector 30 or even the object 20 to move instead of the source 10 or together with the source 10. In yet another embodiment, more than one component may be movable, controlled by the positional subsystem 26. Thus, radiographic projections may be obtained at various angles through the object 20 by changing the relative positions of the source 10, the object 20, and the detector 30 via the positional subsystem 26 according to various embodiments illustrated herein below in detail. As noted above, certain systems may employ distributed sources of radiation, and such systems may not require such displacement of the sources.

Additionally, as will be appreciated by those skilled in the art, the source of radiation may be controlled by an X-ray controller 52 disposed within controlling device 50. Particularly, the X-ray controller 52 is configured to provide power and timing signals to the X-ray source 10. A motor controller 54, also disposed within controlling device 50, may be utilized to control the movement of the positional subsystem 26.

Further, the controlling device 50 is also illustrated comprising a data acquisition system 56. The detector 30 is typically coupled to the controlling device 50, and more particularly to the data acquisition system 56. The data acquisition system 56 receives data collected by readout electronics of the detector 30. The data acquisition system 56 typically receives sampled analog signals from the detector 30 and converts the data to digital signals for subsequent processing by a computer 70. In another embodiment, the sampled signals are converted to digital signals within the detector 30, and the digital signals are communicated by a wired, optical or wireless interface to the data acquisition system 56.

The computer 70 is typically coupled to the controlling device 50. The data collected by the data acquisition system 56 may be transmitted to the computer 70 and moreover, to a memory 60. It should be understood that any type of memory adapted to store a large amount of data may be utilized by such an exemplary system 100. The memory 60 stores the vertices of the collimation device, which may be used for further processing in defining the area of interest of the image. The computer 70 is also configured to receive commands and scanning parameters from an operator via an operator workstation 80, typically equipped with a keyboard and other input devices. Computer 70 also performs the reconstruction of a volumetric image from the projection image data set. The projection images or the volumetric images may be transmitted to the display 90 for review and moreover, to a memory 60 for storage. An operator may control the system 100 via the input devices. Thus, the operator may observe the projection images or the reconstructed volumetric image and other data relevant to the system from computer 70, initiate imaging, and so forth. All these functions may be carried out by a single computer, or they may be distributed across several computers, maybe comprising specific hardware, for example for fast reconstruction.

A display 90 coupled to the operator workstation 80 may be utilized to observe the reconstructed volumetric image, or a suitably processed version thereof, and to control imaging. It should be further noted that the computer 70 and the operator workstation 80 may be coupled to other output devices, which may include standard or special purpose computer monitors and associated processing circuitry. One or more of the operator workstations 80 may be further linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

In the tomosynthesis imaging system 100, then source 10 emits an X-ray of radiation from a focal point. In an embodiment the collimator 30 is placed between the source 10 and the object 20. The stream of radiation is directed towards a particular region of the object. The particular region of the object is typically chosen by an operator so that the most useful scan of a region may be made. In a typical operation of the system 100, X-ray source 10 is positioned opposite the detector 40, with the object 20 (patient or other subject or object of interest) and the collimator disposed between, the X-ray source 10 may then project an X-ray beam from the focal point towards the detector 30, through the object 20. The collimator defines the field of view in the image and limits the excess exposure of radiation to the object. Since the initial beam is passed through the collimator, the beam impinging with the object will have the field of view of the collimator. Once the beam interacts with the object being imaged the intensities of the beam will be modulated by the characteristics of the object.

The computer is programmed to define an area of interest of the plurality of projection image acquired by the data acquisition. The area of interest is defined based on the field of view of the collimator from the projected images. The computer is also programmed to back project the area of interest of each projection image for reconstructing at least one 3D image. The processed data, the data of the projection image falling within the area of interest, are then typically input to a reconstruction algorithm to formulate a volumetric image of the scanned volume. In tomosynthesis, a limited number of projection images are acquired, typically thirty or less, each at a different angle relative to the object and detector. Reconstruction algorithms are typically employed to perform the reconstruction on this projection image data to produce the volumetric image. Reconstructed volumetric images may be displayed to show the three-dimensional characteristics of these features and their spatial relationships. The reconstructed volumetric image is typically arranged in slices. In some embodiments, a single slice may correspond to features of the imaged object located in a plane that is essentially parallel to the detector plane. Though the reconstructed volumetric image may comprise a single reconstructed slice representative of structures at the corresponding location within the imaged volume, more than one slice image is typically computed.

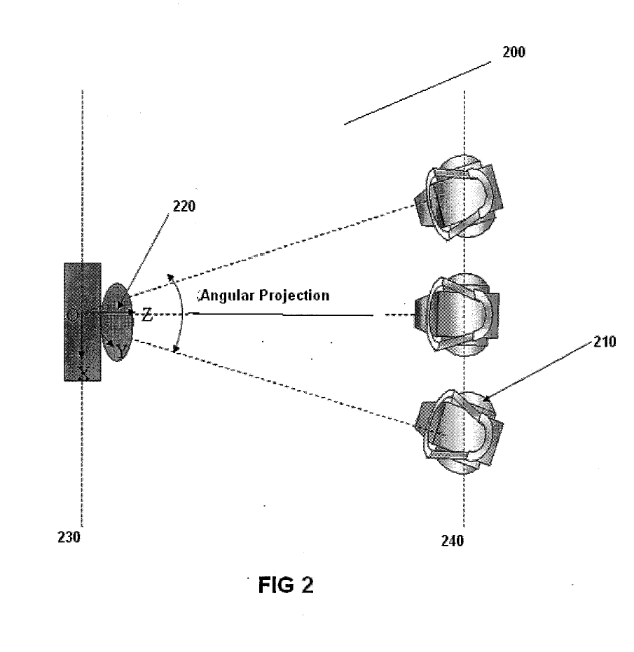

FIG. 2 illustrates a schematic diagram illustrating a method of tomosynthesis in accordance an embodiment of the present invention. Tomosynthesis is an advanced application in X-ray radiographic imaging that allows retrospective reconstruction of an arbitrary number of tomographic planes of object from a set of low-dose projection images acquired over a limited angle. Digital tomosynthesis is reconstruction of three-dimensional (3D) images from two-dimensional (2D) projection images of an object. The digital tomosynthesis system 200 comprises an X-ray source 210 and a 2-D X-ray detector 230, which is a digital detector. The object 220, being imaged is placed between the source 210 and the detector 230. In typical digital tomosynthesis systems, during data acquisition, the X-ray source 210 is rotated by a gantry ( not shown) on an arc through a limited angular range about a pivot point and a set of projection radiographs of the object are acquired by the detector 230 at discrete locations of the X-Ray source 210. During the acquisition, the X-ray source 210 travels along the direction illustrated in FIG. 2, and rotates in synchrony such that the X-ray beam always point to the detector during the acquisition. The detector is maintained at a stationary position as the radiographs are acquired. Furthermore, the source 210 may be moved, typically within a plane 240 (although it may be moved outside of a single plane), which is substantially parallel to the detector 230. A plurality of radiographic views from different view angles may thus be collected by the detector 230.

In one embodiment the distance between the source 210 and the detector 230 is approximately 180 cm and the total range of motion of the source 210 is between 31.5 cm and 131 cm, which translates to ±5° to ±20° where 0° is a centered position. In this embodiment, typically at least eleven projections are acquired, covering the fall angular range.

The detector 230 is generally formed by a plurality of detector elements, generally corresponding to pixels, which sense the intensity of X-rays that pass through and around a region of interest. Depending upon the X-ray attenuation and absorption for the intervening structures, the radiation impacting each pixel region will vary. In one embodiment, the detector 230 consists of a 2,048×2,048 rectangular array of elements, with a pixel size of 200 μm×200 μm, though other configurations and sizes of both detector 230 and its pixels are, of course, possible. Each detector element produces an electrical signal that represents the intensity of the X-ray beam at the position of the element on the detector.

In one embodiment, detector 230 is an amorphous silicon flat panel digital X-ray detector. However, detector 230 may be any X-ray detector that provides a digital projection image including, but not limited to, a charge-coupled device (CCD), a digitized film screen, or another digital detector such as a direct conversion detector. The low electronic noise and fast read-out times of such detectors enable acquisitions with many projections at low overall patient dose compared to competing detector technologies.

Once the projection radiographs have been obtained, they are then spatially translated with respect to each other and superimposed in such a manner that the images of structures in the tomosynthesis plane overlap exactly. The images of structures outside the tomosynthesis plane do not overlap exactly, resulting in a depth dependent blurring of these structures. By varying the amount of relative translation of the projection radiographs, the location of the tomosynthesis plane can be varied within the object. Each time the tomosynthesis plane is varied, the image data corresponding to the overlapping structures is superimposed and a 2-D image of the structure in the tomosynthesis plane is obtained. Once a complete set of 2-D images of the object has been obtained, a 3-D image of the object is generated from the set of 2-D images.

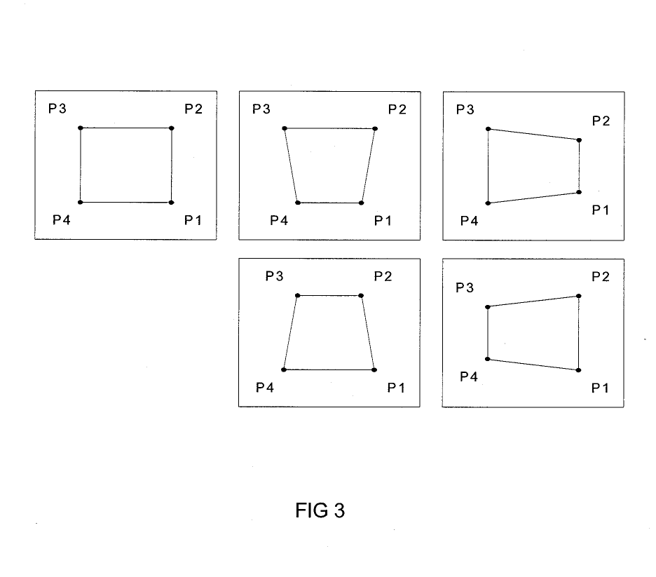

FIG. 3 illustrates exemplary field of views seen in projection images in a tomosynthesis system in accordance with different embodiments of the present invention. X-ray collimators are used in medical imaging applications to limit the field of an X-ray beam to a shape and size just sufficient to expose the area requiring diagnosis in a patient's body, and prevent unnecessary exposure of the surrounding area to X-rays. In other terms, a collimator helps to minimize the X-ray exposure and maximize the efficiency of X-ray dosage, to obtain optimum amount of pictorial data for diagnosis. Generally, X-ray collimators provide a reduction in the field of an X-ray beam, by collimating the X-ray beam either to a substantial rectangular shape, a circular shape or a combination thereof, depending upon the configuration of the leaves or blades that block the X-rays for field reduction. A pre-patient collimator is often used on digital tomosynthesis system to confine the field of view (FOV) in the projection images so that unnecessary radiation can be avoided as much as possible. The FOV usually has a polygonal shape (either a rectangular or trapezoidal shape) in most of commercially available x-ray medical imaging products. FIG. 3 illustrates some typical FOV shapes seen in the projection images. The vertices defining field of view of the collimator is indicated as P1, P2, P3 and P4. The collimator is typically made of metal materials that make x-ray hard to penetrate through so that very less photons arrive at the detector in those collimated area. After the negative log, however, these area appear as high intensity (bright) area.

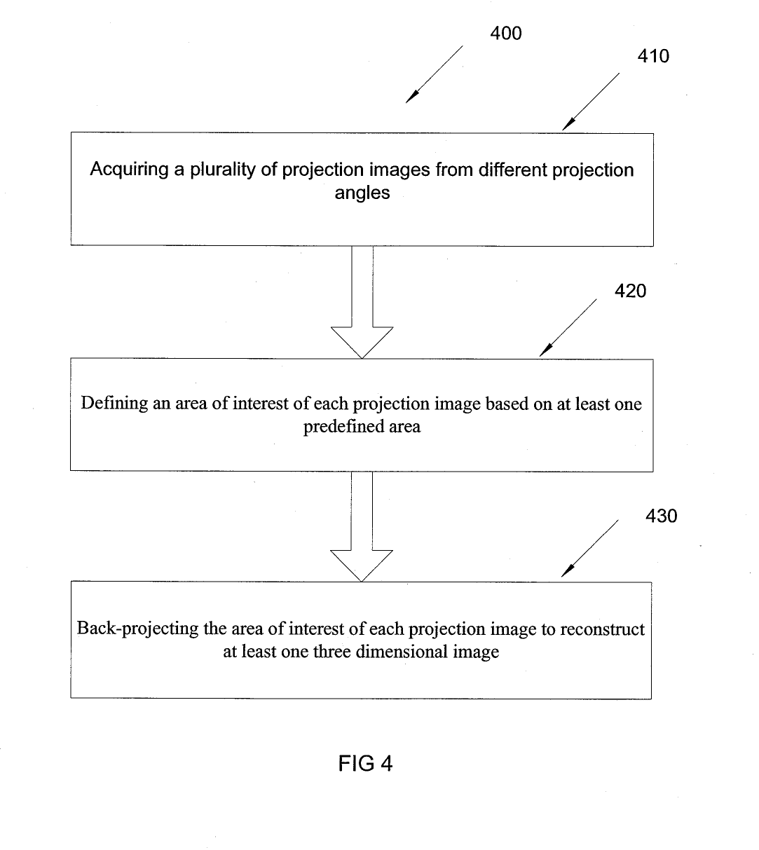

FIG. 4 is a high level flowchart depicting exemplary steps of collimation artifacts reduction method in a tomosynthesis imaging system in accordance with an embodiment of the present invention. The flowchart 400 illustrates an artifacts reduction method of an embodiment. At block 410, a plurality of images is acquired from different projection angles. The images acquired are 2D images. Image acquisition can be performed, for example, using any one of a number of techniques (e.g., using a digital detector), provided the views can be made in (or converted to) digital form. At block 420, an area of interest of each projection image is defined based on a predefined area. In one embodiment the predefined area is the field of view defined by the x-ray collimator. The field of view of the collimator is identified for each of the projection images. At block 430, the projection images falling within the predefined area is back projected to reconstruct at least one 3-D image. FIG. 5 describes in greater detail, the specific steps performed by the collimation artifacts reduction method of the present technique for minimizing collimator artifacts.

FIG. 5 is a flowchart describing, in greater detail, exemplary steps of collimation artifacts reduction method for reducing the collimator artifacts in accordance with aspects of the present technique. The flowchart 500 shows the detailed steps of method of reducing artifacts in an embodiment of the invention. In block 510, an X-ray beam is passed through a collimation device. As mentioned earlier the X-ray source is rotated through a limited angular range about a pivot point and is in rotates in synchrony such that the X-ray beam always point to the detector during the acquisition. At block 520, the X-ray beam from different angle of projection interacts with the object. The intensity of the beam will be modulated by the characteristics of the object. At block 530, the detector obtains plurality of the images from different projection angles. Obtaining plurality of images by the detector is explained in FIG. 2. This is generally termed as projection images.

At block 540, the vertices defining the field of view of the collimator is identified. This could be strategically achieved in two steps: First, most of commercial X-ray collimators have built-in positioning feedback with an accuracy of 1 cm. Although the accuracy is far from enough, the information can be used as a starting point. Second, based on the collimator feedback, an image processing algorithm is typically used to refine the coordinates of the vertices by means of image search. At block 550, an area of interest of each projection image is identified. In an embodiment, the area of interest is identified based on the field of view of the collimator. Due to perspective projection, the vertices of the collimator will be projected to slightly different locations on the detector in relative to its origin, resulting the size and shape of the field of view defined by the collimator are different across projection images. Hence the vertices of the collimator are identified for each projection image. At block 560, part of the projection image falling within the field of view of the collimator is identified and is back-projected to reconstruct the image. Various back-projection techniques mention may be used in reconstructing the image.

At block 570, cropping of the reconstructed image is performed. This step is used if multiple slice images are reconstructed. The application of collimation and back projection of the projection image can result in an inadvertent effect: the image size of the reconstructed slice images is different (depending on the height). The reason for doing cropping is the cone-beam geometry. That is, the X-ray beam from a point source has a cone shape. Most of commercial x-ray equipment today utilizes point source. Because of the cone-beam geometry, when back-project projection data to reconstruct slice images, the slice image that is closer to the source will have smaller field of view than any slice further from the source. This effect results in the slice images with different image sizes. Hence all slice images are cropped to the same size irrespective of their distance to the source. In an embodiment the cropping is done based on a predefined area. The predefined area includes areas defined by the vertices of the field of view of the collimator in one or more projection images, or the field of view of the collimator defined in one or more reconstructed images. However there are many ways to do so, such as: crop all slice to a predefined size, crop all slice to the field of view of the bottom slice image, crop all slices to the field of view of the middle slice, crop all slices to the field of view of the top slice, crop all slices to the filed of view of the zer0-degree projection image, etc. Or the cropping may be done using P1˜P4 information from one or more projection images, P1˜P4 information from one or more slice images, or a mixture of both

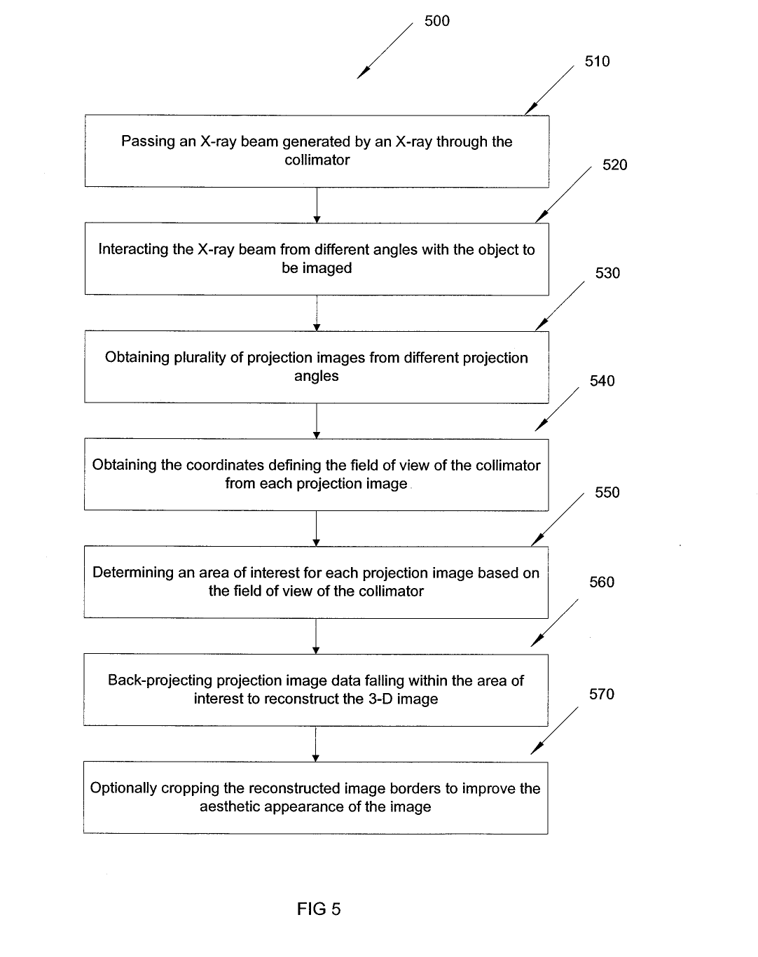

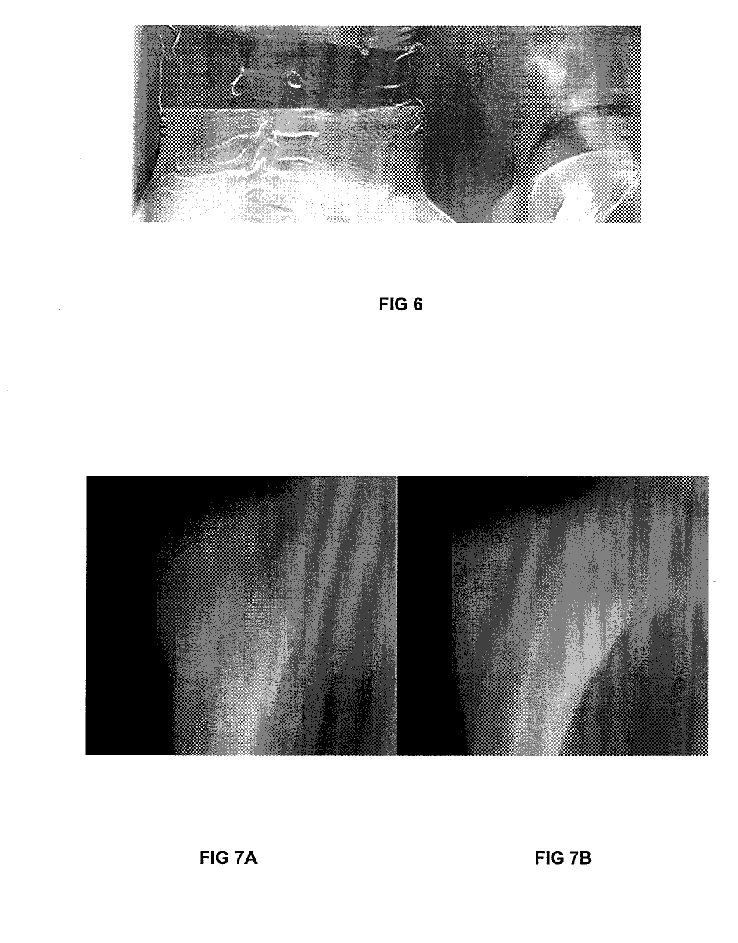

FIG. 6 illustrates a reconstructed image in a tomographic synthesis imaging system according to the prior art. As mentioned earlier, digital tomosynthesis employs the back-projection algorithm or its variants to reconstruct the desired 3-D images or slice images. Normally the projection images with collimator edges of high intensity is back-projected into slice images. This results in corrupting the consistency of projection data, and thus line artifacts like those shown in FIG. 6 is introduced in the image.

FIG. 7A and FIG. 7B illustrate a side-by-side comparison of reconstructed image before (FIG. 7A) and after (FIG. 7B) using the method disclosed in an embodiment of the invention. FIG. 7A shows a reconstructed image without using any method for reducing the artifacts. FIG. 7B shows a reconstructed image using an embodiment of the invention. The projection image falling within the field of view of the collimator is back-projected to reconstruct the image. The line artifacts in the image illustrated in FIG. 7B has been reduced considerably and the image quality of the image has been improved significantly.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

What is claimed is:

1. A method of reducing artifacts in tomosynthesis reconstructed images, said method comprising the steps of:
(a) acquiring a plurality of projection images from different projection angles;
(b) defining an area of interest of each projection image based on at least one predefined area; and
(c) back-projecting the area of interest of each projection image to reconstruct at least one three dimensional image.

2. A method as in claim 1, wherein the step of acquiring plurality of projection images further comprises moving a source of radiation and an array of detectors in relative to each other.

3. A method as in claim 2, wherein the source of radiation generates a beam of radiation and the array of detectors detects plurality of projection images from different angles.

4. A method as in claim 2, further comprises passing the beam of radiation through at least one collimator, wherein the collimator is configured to be of any beam attenuating structure having a number of vertices to identify field of view of the collimator.

5. A method as in claim 1, wherein the at least one predefined area includes field of view of at least one collimator.

6. A method as in claim 1, wherein the step of defining the area of interest of each projection image further comprises:
(a) identifying vertices of the defining field of view of the collimator for each of the plurality of images;
(b) refining the coordinates of the vertices by means of image-based detection algorithms; and
(c) Storing the identified vertices for each image separately.

7. method as in claim 6, further comprises:
(a) obtaining coordinates of the vertices defining the field of view of the collimator for each projection image; and
(b) identifying image pixels of each projection image falling within the field of view of the collimator for each projection image.

8. A method as in claim 7, wherein plurality of projection images comprises X-ray images.

9. A method as in claim 6, wherein the area of interest of the projection image is defined by the projection of the collimator onto the projection image.

10. A method as in claim 1, further comprising cropping reconstructed three dimensional images, wherein boarders of the images are cropped based on at least one pre-defined area.

11. A method as in claim 10, wherein the at least one pre-defined area includes areas defined by the vertices of the field of view of the collimator in one or more projection images, or the field of view of the collimator defined in one or more reconstructed images.

12. A system to construct a three-dimensional image of an object using tomosynthesis, the system comprising:
(i) a computer;
(ii) said computer programmed to:
(a) define area of interest of a plurality of projection image after image data acquisition, based on at least one predefined area;
(b) back project the area of interest of each projection image for reconstructing at least one 3D image.

13. The system as in claim 12, wherein the predefined area includes field of view of at least one collimator placed in a tomosynthesis system.

14. The system as in claim 12, wherein the area of interest of each projection image includes pixels of projection images falling within the field of view of the collimator.

15. The system as in claim 14, wherein the area of interest of projection images are identified by a computer program.

16. The system as in claim 15, wherein the computer program performs defining the area of interest of each projection image based on field of view of at least one collimator.

17. The system as in claim 12, wherein the field of view of the collimator is identified by using techniques selected from the group consisting of accurate feedback algorithm, image-based detection algorithm, or a combination of the two.

18. A tomosynthesis system with improved artifacts reduction comprising:
an X-ray source configured to project an X-ray beam from a plurality of positions through an object to be imaged;
a collimator placed between the source and object to be imaged;
a detector configured to produce a plurality of signals corresponding to the X-ray beam; and
a computer configured to process the plurality of signals to generate a plurality of projection images, each projection image comprising a respective plurality of pixels, wherein the computer is further configured to define area of interest of a plurality of projection image after image data acquisition, based on at least one predefined area; and back project the area of interest of each projection image for reconstructing at least one 3D image.

19. The system as in claim 18, wherein predefined area includes field of view of at least one collimator placed in a tomosynthesis system.

20. The system as in claim 18, the area of interest of each projection image includes pixels of projection images falling within the field of view of the collimator.
